(19) United States
(12) Patent Application Publication
(10) Pub. No.: US 2014/0293815 A1
(43) Pub. Date: Oct. 2, 2014

(54) METHOD AND APPARATUS FOR OBTAINING CHANNEL STATE INFORMATION

(71) Applicant: Huawei Technologies Co., Ltd., Shenzhen (CN)

(72) Inventors: Liang XIA, Shenzhen (CN); Mingyu Zhou, Shenzhen (CN)

(73) Assignee: Huawei Technologies Co., Ltd., Shenzhen (CN)

(21) Appl. No.: 14/305,279

(22) Filed: Jun. 16, 2014

Related U.S. Application Data
(63) Continuation of application No. PCT/CN2012/086235, filed on Dec. 8, 2012.

(30) Foreign Application Priority Data
Dec. 14, 2011 (CN) 201110418223.6

(51) Int. Cl. H04W 24/10; H04B 17/00

(52) U.S. Cl. CPC H04W 24/10; H04B 17/0067
USPC 370/252

(57) ABSTRACT

Embodiments of the present application disclose a method and an apparatus for obtaining channel state information. The method includes: first, receiving, by a user equipment, at least two channel state information CSI measurement reference resource sets sent by a base station; then, measuring, by the user equipment according to each CSI measurement reference resource set of the at least two channel state information CSI measurement reference resource sets, CSI between the user equipment and a transmission point and/or a transmission point combination corresponding to each CSI measurement reference resource set, and obtaining a feedback mechanism satisfying a requirement of the CSI between the user equipment and the transmission point and/or the transmission point combination; and finally, feeding back, by the user equipment, a measurement result to the base station through the same or different feedback mechanisms.

### CROSS-REFERENCE TO RELATED APPLICATION

This application is a continuation of International Application No. PCT/CN2012/086235, filed on Dec. 8, 2012, which claims priority to Chinese Patent Application No. 201110418223.6, filed on Dec. 14, 2011, both of which are hereby incorporated by reference in their entireties.

### TECHNICAL FIELD

The present application relates to the field of communications system, and in particular, to a method and an apparatus for obtaining channel state information.

### BACKGROUND

In a conventional wireless communications system, each user equipment (User Equipment, UE) usually receives data and signaling information sent from one cell only, where each cell includes one or more transmission points having a transmitting and receiving apparatus. One transmission point having a transmitting and receiving apparatus may correspond to one or more antennas. Persons skilled in the art may easily understand that a “cell” or a “transmission point corresponding to the cell” in the following indicate the same meaning.

Usually, to enable a base station to perform reasonable scheduling, the base station needs to learn channel state information (Channel State Information, CSI) of a wireless channel between a transmission point and a UE. The UE usually measures a reference signal (Reference Signal, RS) sent by the transmission point, and feeds back a measurement result to the base station, so as to obtain the information, for example, CIS-RS in an LTE-Advanced (further advancement of LTE) system. In a CoMP (Coordinated Multiple Point transmission/reception, coordinated multiple point transmission/reception) system, to enable multiple transmission points to perform reasonable coordination, a base station in charge of scheduling needs to learn CSI of wireless channels between the multiple transmission points and the UE.

In the prior art, a base station sends information of one RS pattern and information of a group of RS available resources to a UE; on a first resource, a transmission point 1 sends an RS according to the RS pattern, and a transmission point 2 sends an RS not according to the RS pattern, where the first resource is a non-empty subset of the group of RS available resources; and on a second resource, the transmission point 2 sends the RS according to the RS pattern, and the transmission point 1 sends the RS not according to the RS pattern, where the second resource is a non-empty subset of the group of RS available resources. The UE measures the RSs on the two resources according to the RS pattern, and feeds back a measurement result; and the base station receives the measurement result fed back by the UE to obtain CSI between the transmission point 1 and the UE and CSI between the transmission point 2 and the UE.

In the prior art, obtaining CSI of wireless channels between different transmission points and a UE can be implemented. However, CSI on two resources is fed back to a base station by sharing the same feedback mechanism; as a result, a problem that when a user equipment feeds back CSI to a base station, a feedback mechanism is inflexible is caused.

### SUMMARY

Embodiments of the present application provide a method and an apparatus for obtaining channel state information, so as to solve a problem that a feedback mechanism is inflexible when obtaining CSI of wireless channels between different transmission points and a user equipment is implemented.

The embodiments of the present application adopt the following technical solutions.

A method for obtaining channel state information includes: receiving, by a user equipment, at least two channel state information CSI measurement reference resource sets sent by a base station, where reference signal RS resources included in different CSI measurement reference resource sets are different, RSs included in the different CSI measurement reference resource sets have different RS characteristics, and RSs included in the same CSI measurement reference resource set have the same RS characteristic;

measuring, by the user equipment according to each CSI measurement reference resource set of the at least two CSI measurement reference resource sets, CSI corresponding to each CSI measurement reference resource set, and obtaining a feedback mechanism corresponding to each CSI measurement reference resource set; and

feeding back, by the user equipment, a measurement result to the base station through the feedback mechanism, where the measurement result is CSI between the user equipment and any one or a combination of transmission points among at least two transmission points each corresponding to each CSI measurement reference resource set, and the transmission point is a device providing a service for the user equipment.

A user equipment includes:

a receiving unit, configured to receive at least two channel state information CSI measurement reference resource sets sent by a base station, where reference signal RS resources included in different CSI measurement reference resource sets are different, RSs included in the different CSI measurement reference resource sets have different RS characteristics, and RSs included in the same CSI measurement reference resource set have the same RS characteristic;

a measurement obtaining unit, configured to measure, according to each CSI measurement reference resource set of the at least two CSI measurement reference resource sets received by the receiving unit, CSI corresponding to each CSI measurement reference resource set, and obtain a feedback mechanism corresponding to each CSI measurement reference resource set; and

a feedback unit, configured to feed back a measurement result to the base station through the feedback mechanism obtained by the measurement obtaining unit, where the measurement result is CSI between the user equipment and any one or a combination of transmission points among at least two transmission points each corresponding to each CSI measurement reference resource set, and the transmission point is a device providing a service for the user equipment.

Another method for obtaining channel state information includes:

sending, by a base station, at least two channel state information CSI measurement reference resource sets to a user equipment, so that the user equipment measures, according to each CSI measurement reference resource set of the at least two CSI measurement reference resource sets, CSI corresponding to each CSI measurement reference resource set, and obtains a feedback mechanism corresponding to each CSI measurement reference resource set; and

receiving, by the base station, a measurement result that is fed back by the user equipment through the feedback mechanism, where the measurement result is CSI between the user equipment and any one or a combination of transmission points among at least two transmission points each corresponding to each CSI measurement reference resource set, and the transmission point is a device providing a service for the user equipment.

A base station includes:

a sending unit, configured to send at least two channel state information CSI measurement reference resource sets to a user equipment, so that the user equipment measures, according to each CSI measurement reference resource set of the at least two CSI measurement reference resource sets, CSI corresponding to each CSI measurement reference resource set, and obtains a feedback mechanism corresponding to each CSI measurement reference resource set; and

a receiving unit, configured to receive a measurement result that is fed back to the receiving unit by the user equipment through the feedback mechanism obtained by the user equipment, where the measurement result is CSI between the user equipment and any one or a combination of transmission points among at least two transmission points each corresponding to each CSI measurement reference resource set, and the transmission point is a device providing a service for the user equipment.

With the method and apparatus for obtaining channel state information provided in the embodiments of the present application, first of all, a user equipment receives at least two channel state information CSI measurement reference resource sets sent by a base station; then, the user equipment measures, according to each CSI measurement reference resource set of the at least two channel state information CSI measurement reference resource sets, CSI between the user equipment and a transmission point and/or a transmission point combination corresponding to each CSI measurement reference resource set, and obtains the same or different feedback mechanisms satisfying a requirement of the CSI between the user equipment and the transmission point and/or the transmission point combination; and finally, the user equipment feeds back a measurement result to the base station through the same or different feedback mechanisms. In the prior art, CSI between a user equipment and different transmission points can be measured, but a feedback mechanism is inflexible when the user equipment feeds back a measurement result to a base station. In the solutions provided in the embodiments of the present application, a user equipment adjusts a feedback mechanism according to different requirements on the feedback mechanism of CSI between the user equipment and different transmission points corresponding to CSI measurement reference resource sets sent by a base station, thereby solving a problem that a feedback mechanism is inflexible when a user equipment feeds back a measurement result to a base station in the prior art.

### BRIEF DESCRIPTION OF DRAWINGS

To describe the technical solutions in the embodiments of the present application more clearly, the accompanying drawings required for describing the embodiments are introduced briefly in the following. Apparently, the accompanying drawings in the following description only show some of the embodiments of the present application, and persons of ordinary skill in the art may also obtain other drawings according to these accompanying drawings without creative efforts.

FIG. 1 is a flow chart of a method for obtaining channel state information according to an embodiment of the present application;

FIG. 2 is a schematic structural diagram of a user equipment according to an embodiment of the present application;

FIG. 3 is a flow chart of another method for obtaining channel state information according to an embodiment of the present application;

FIG. 4 is a schematic structural diagram of a base station according to an embodiment of the present application;

FIG. 5 is a configuration diagram of a sending time point of a reference signal according to an embodiment of the present application;

FIG. 6 is a pattern of an RS sent by a transmission point 1 on a first RS resource according to an embodiment of the present application;

FIG. 7 is a pattern of an RS sent by a transmission point 2 on a first RS resource according to an embodiment of the present application;

FIG. 8 is a pattern of an RS sent by a transmission point 1 on a second RS resource according to an embodiment of the present application;

FIG. 9 is a pattern of an RS sent by a transmission point 2 on a second RS resource according to an embodiment of the present application;

FIG. 10 is a pattern of an RS sent by a transmission point 1 on a first RS resource according to an embodiment of the present application;

FIG. 11 is a pattern of an RS sent by a transmission point 1 on a second RS resource according to an embodiment of the present application; and

FIG. 12 is a pattern of an RS sent by a transmission point 2 on a second RS resource according to an embodiment of the present application.

### DESCRIPTION OF EMBODIMENTS

The technical solutions in the embodiments of the present application are clearly described in the following with reference to the accompanying drawings in the embodiments of the present application. Apparently, the embodiments to be described are only a part rather than all of the embodiments of the present application. All other embodiments obtained by persons skilled in the art based on the embodiments of the present application without creative efforts shall fall within the protection scope of the present application.

To make advantages of the technical solutions of the present application clearer, the present application is described in detail in the following with reference to the accompanying drawings and the embodiments.

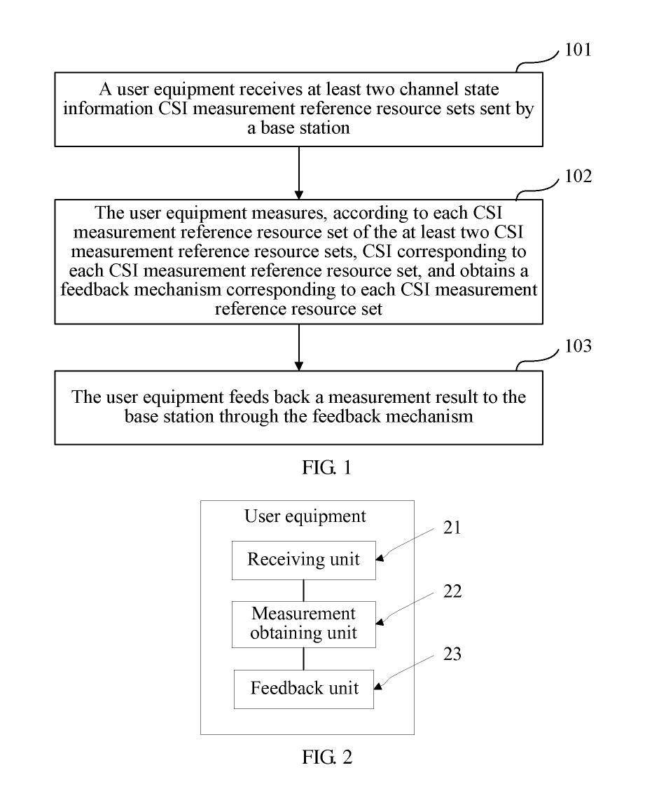

FIG. 1 shows a method for obtaining channel state information according to an embodiment of the present application, and the method includes:

101: A user equipment receives at least two channel state information CSI measurement reference resource sets sent by a base station.

Reference signal RS resources included in different CSI measurement reference resource sets are different; and RSs included in the different CSI measurement reference resource sets have different RS characteristics, and RSs included in the same CSI measurement reference resource set have the same RS characteristic. The RS resource is a time dimension resource (such as a sub-frame) or a frequency dimension resource (such as a sub-band) including an RS; the RS characteristic includes a transmission point that sends the RS, and a configuration of the RS; and the configuration of the RS includes the number of RS antenna ports, an RS pilot pattern, an RS period, and an RS sub-frame offset.

102: The user equipment measures, according to each CSI measurement reference resource set of the at least two CSI measurement reference resource sets, CSI corresponding to each CSI measurement reference resource set, and obtains a feedback mechanism corresponding to each CSI measurement reference resource set.

Different CSI measurement reference resource sets in the at least two CSI measurement reference resource sets correspond to the same or different feedback mechanisms. The feedback mechanism may include a feedback mode, a feedback period, a frequency domain granularity, feedback triggering signaling, and the like.

103: The user equipment feeds back a measurement result to the base station through the feedback mechanism.

The measurement result may be CSI between the user equipment and any one or a combination of transmission points among at least two transmission points each corresponding to each CSI measurement reference resource set; and the transmission point is a device providing a service for the user equipment, and specifically, the transmission point may be a device such as an antenna.

For example, two transmission points exist, which are a transmission point 1 and a transmission point 2. Multiple RS sending time point configurations are defined in the prior art. As shown in FIG. 5, when an RS sending time point configuration I_{CSI-RS} is 36, an RS period is 40 transmission time intervals TTI, and an RS offset is 1, which indicates that the RS is sent on TTIs at time points of 1, 41, 81, 121, and the like. In this example, the RS sending time point configuration I_{CSI-RS} that the base station configures for the UE is 0, which indicates that the RS period is 5 TTIs, and the RS offset is 0, that is, the RS is sent on TTIs at time points of 0, 5, 10, 15, and the like. An RS pattern that the base station configures for the UE is two REs: (9, 5) and (9, 6). The RS pattern represents an RS sending time point and frequency point (referred to as a time-frequency grid point). A TTI serves as a time unit for sending of a signal. The length of one TTI is 1 ms, including 14 symbols. One physical resource block (Physical Resource Block, PRB) is 12 sub-carriers within one TTI. Each sub-carrier on each symbol is referred to as one resource element (Resource Element, RE). Therefore, one PRB includes 12×14 REs, and each group of REs (including one or more REs) may be represented through (k, l).

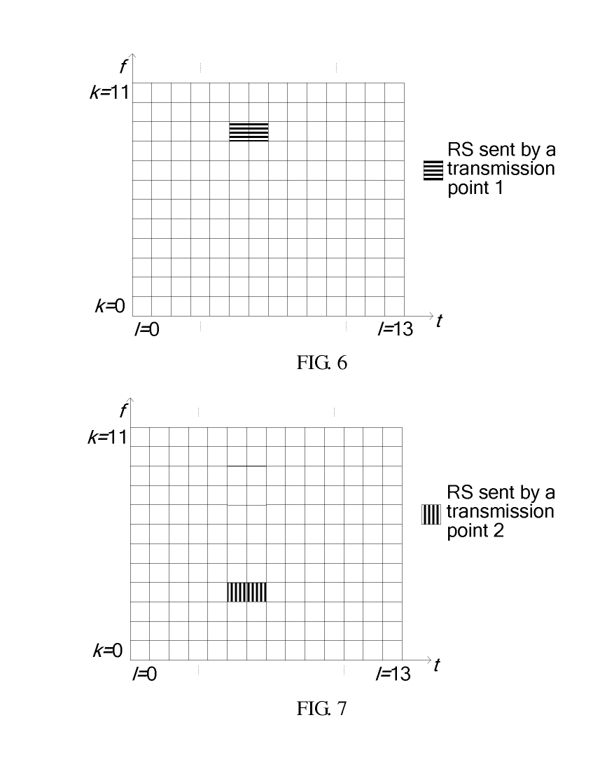

On TTIs whose serial numbers are 0, 10, 20, . . . , (a first RS resource), patterns of RSs sent by the transmission point 1 and the transmission point 2 are as shown in FIG. 6 and FIG. 7. For the same physical resource block PRB, the pattern of the RS sent by the transmission point 1 is two REs: (9, 5) and (9, 6), and the pattern of the RS sent by the transmission point 2 is two REs: (3, 5) and (3, 6).

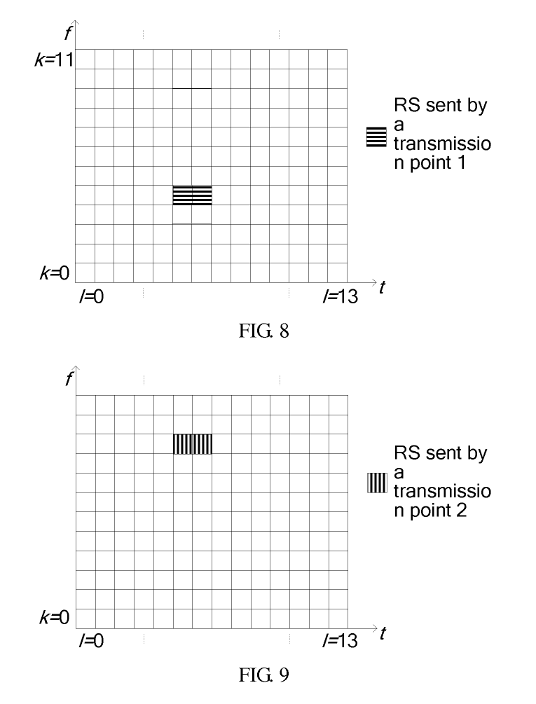

On TTIs at the time points of 5, 15, 25, . . . , (a second RS resource), patterns of RSs sent by the transmission point 1 and the transmission point 2 are as shown in FIG. 8 and FIG. 9. For the same PRB, the pattern of the RS sent by the transmission point 1 is two REs: (4, 5) and (4, 6), and the pattern of the RS sent by the transmission point 2 is two REs: (9, 5) and (9, 6).

An RS measured by the UE on the TTIs at the time points of 0, 10, 20, . . . , and on the two REs (9, 5) and (9, 6), which form the pattern of the RS, is sent from the transmission point 1, while the TTIs at the time points of 0, 10, 20, . . . , belong to a first CSI measurement reference resource set. Therefore, the UE can obtain first CSI between the transmission point 1 and the UE, and feed back the first CSI according to a feedback mechanism of the first CSI measurement reference resource set. An RS measured on the TTIs at the time points of 5, 15, 25, . . . , and on the two REs (9, 5) and (9, 6), which form the pattern of the RS, is sent from the transmission point 2, while the TTIs at the time points of 5, 15, 25, . . . , belong to a second CSI measurement reference resource set. Therefore, the UE can obtain second CSI between the transmission point 2 and the UE, and feed back the second CSI according to a feedback mechanism of the second CSI measurement reference resource set.

Specifically, the first CSI measurement reference resource set may be indicated by using a bitmap. Each bit of the bitmap corresponds to each TTI or TTI set. For example, if a value of a bit is “1”, it indicates that a TTI or TTI set corresponding to the bit belongs to the first CSI measurement reference resource set; and if a value of a bit is “0”, it indicates that a TTI or TTI set corresponding to the bit does not belong to the first CSI measurement reference resource set. The TTI set may be all TTIs within one RS period. Further, the second CSI measurement reference resource set may also be indicated by using a bitmap, and a specific method is similar to that of the first CSI measurement reference resource set, which is not described herein again.

For example, the length of the bitmap is 40 bits, which correspond to 40 consecutive TTIs. The first CSI measurement reference resource set may be represented by (10000 00000 10000 00000 10000 00000 10000 00000), or represented by (11111 00000 11111 00000 11111 00000 11111 00000).

When an RS resource adopts a frequency dimension, a method is similar to the foregoing method of the time dimension, as long as a TTI is replaced with a PRB, and a time point is replaced with a frequency.

Optionally, when the measurement result that needs to be fed back by the user equipment to the base station through the feedback mechanism is CSI between the user equipment and a transmission point combination, after receiving each CSI measurement reference resource set of the at least two channel state information CSI measurement reference resource sets sent by the base station, the user equipment further receives an RS configuration corresponding to each CSI measurement reference resource set, where the RS configuration includes at least one of the following information: the number of RS antenna ports, an RS pilot pattern, an RS period, and an RS sub-frame offset.

An RS pattern represents an RS sending time point and frequency point (referred to as a time-frequency grid point). A TTI serves as a time unit for sending of a signal. The length of one TTI is 1 ms, including 14 symbols. One physical resource block (Physical Resource Block, PRB) is 12 sub-carriers within one TTI. Each sub-carrier on each symbol is referred to as one resource element (Resource Element, RE). Therefore, one PRB includes 12×14 REs, and each group of REs (including one or more REs) may be represented through (k, l).

At this time, the user equipment may measure, according to each CSI measurement reference resource set of the at least two CSI measurement reference resource sets and the RS configuration corresponding to each CSI measurement reference resource set, CSI between the user equipment and the transmission point combination corresponding to each CSI measurement reference resource set, and obtain a feedback mechanism satisfying a requirement of the CSI between the user equipment and the transmission point combination.

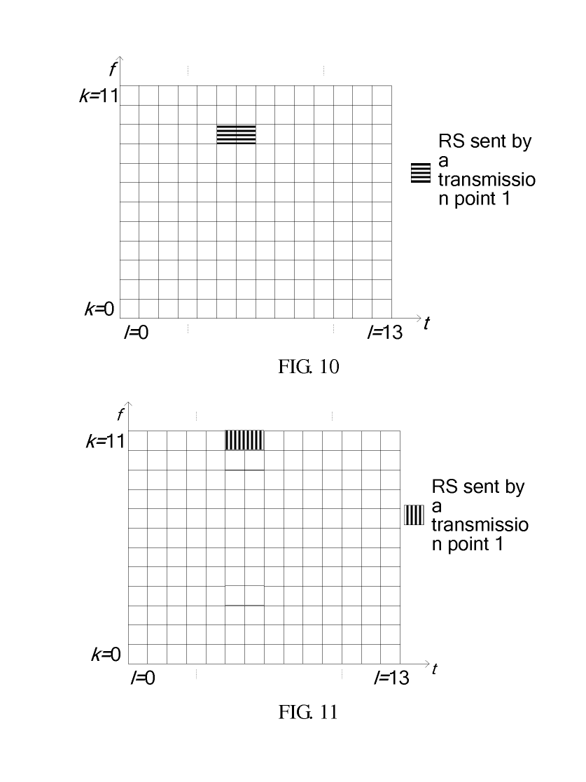

For example, two transmission points exist, which are a transmission point 1 and a transmission point 2. On TTIs at time points of 0, 10, 20, . . . , (a first RS resource), a pattern of an RS sent by the transmission point 1 is as shown in FIG. 10. For the same PRB, the pattern of the RS sent by the transmission point 1 is two REs: (9, 5) and (9, 6).

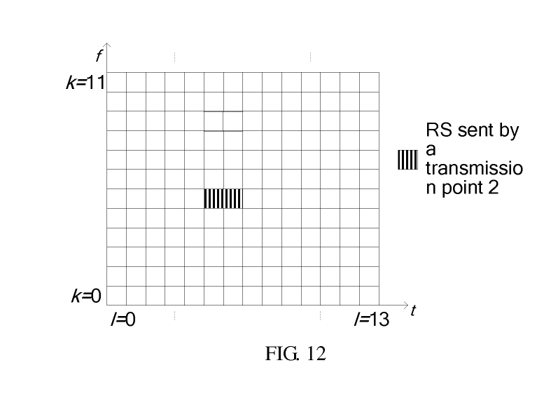

On TTIs whose serial numbers are 5, 15, 25, . . . , (a second RS resource), patterns of RSs sent by the transmission point 1 and the transmission point 2 are as shown in FIG. 11 and FIG. 12. For the same PRB, the pattern of the RS sent by the transmission point 1 is two REs: (11, 5) and (11, 6), and the pattern of the RS sent by the transmission point 2 is two REs: (5, 5) and (5, 6). (11, 5), (11, 6), (5, 5), and (5, 6) form a 4-port RS pattern.

A first RS pattern that the base station configures for the UE is two REs: (9, 5) and (9, 6); and a second RS pattern that the base station configures for the UE is four REs: (11, 5), (11, 6), (5, 5), and (5, 6).

An RS measured by the UE on the TTIs at the time points of 0, 10, 20, . . . , and on the two REs (9, 5) and (9, 6), which form the pattern of the RS, is sent from the transmission point 1, while the TTIs at the time points of 0, 10, 20, . . . , belong to a first CSI measurement reference resource set. Therefore, the UE can obtain first CSI between the transmission point 1 and the UE according to the first CSI measurement reference resource set and the first RS pattern, and feed back the first CSI according to a feedback mechanism of the first CSI measurement reference resource set. An RS measured on the TTIs at the time points of 5, 15, 25, . . . , and on the four REs (11, 5), (11, 6), (5, 5), and (5, 6), which form the pattern of the RS, is jointly sent by the transmission point 1 and the transmission point 2, while the TTIs at the time points of 5, 15, 25, . . . , belong to a second CSI measurement reference resource set. Therefore, the UE can obtain second CSI between the UE and a combination of the transmission point 1 and that transmission point 2 according to the second CSI measurement reference resource set and the second RS pattern, and feed back the second CSI according to a feedback mechanism of the second CSI measurement reference resource set.

Specifically, the first CSI measurement reference resource set may be indicated by using a bitmap. Each bit of the bitmap corresponds to each TTI or TTI set. For example, if a value of a bit is “1”, it indicates that a TTI or TTI set corresponding to the bit belongs to the first CSI measurement reference resource set; and if a value of a bit is “0”, it indicates that a TTI or TTI set corresponding to the bit does not belong to the first CSI measurement reference resource set. The TTI set may be all TTIs within one RS period. Further, the second CSI measurement reference resource set may also be indicated by using a bitmap, and a specific method is similar to that of the first CSI measurement reference resource set, which is not described herein again.

For example, the length of the bitmap is 40 bits, which correspond to 40 consecutive TTIs. The first CSI measurement reference resource set may be represented by (10000 00000 10000 00000 10000 00000 10000 00000) or represented by (11111 00000 11111 00000 11111 00000 11111 00000).

When an RS resource adopts a frequency dimension, a method is similar to the foregoing method of the time dimension, as long as a TTI is replaced with a PRB, and a time point is replaced with a frequency.

FIG. 2 shows a user equipment according to an embodiment of the present application. The user equipment includes: a receiving unit 21, a measurement obtaining unit 22, and a feedback unit 23.

The receiving unit 21 is configured to receive at least two channel state information CSI measurement reference resource sets sent by a base station, where reference signal RS resources included in different CSI measurement reference resource sets are different, RSs included in the different CSI measurement reference resource sets have different RS characteristics, and RSs included in the same CSI measurement reference resource set have the same RS characteristic.

The measurement obtaining unit 22 is configured to measure, according to each CSI measurement reference resource set of the at least two CSI measurement reference resource sets received by the receiving unit 21, CSI corresponding to each CSI measurement reference resource set, and obtain a feedback mechanism corresponding to each CSI measurement reference resource set.

Different CSI measurement reference resource sets in the at least two CSI measurement reference resource sets correspond to the same or different feedback mechanisms. The feedback mechanism may include a feedback mode, a feedback period, a frequency domain granularity, feedback triggering signaling, and the like.

The feedback unit 23 is configured to feed back a measurement result to the base station through the feedback mechanism obtained by the measurement obtaining unit 22.

The measurement result is CSI between the user equipment and any one or a combination of transmission points among at least two transmission points each corresponding to each CSI measurement reference resource set, and the transmission point is a device providing a service for the user equipment.

The receiving unit 21 is further configured to, when the measurement result that needs to be fed back by the feedback unit 23 to the base station through the feedback mechanism obtained by the measurement obtaining unit 22 is CSI between the user equipment and a transmission point combination, receive an RS configuration that is sent by the base station and corresponds to each CSI measurement reference resource set of the at least two CSI measurement reference resource sets, where the RS configuration includes at least one of the following information: the number of RS antenna ports, an RS pilot pattern, an RS period, and an RS sub-frame offset.

An RS pattern represents an RS sending time point and frequency point (referred to as a time-frequency grid point). A TTI serves as a time unit for sending of a signal. The length of one TTI is 1 ms, including 14 symbols. One physical resource block (Physical Resource Block, PRB) is 12 sub-carriers in one TTI. Each sub-carrier on each symbol is referred to as one resource element (Resource Element, RE). Therefore, one PRB includes 12×14 REs, and each group of REs (including one or more REs) may be represented through (k, l).

The measurement obtaining unit 22 may further be configured to measure, according to each CSI measurement reference resource set received by the receiving unit 21 and the RS configuration corresponding to each CSI measurement reference resource set, CSI between the user equipment and the transmission point combination corresponding to each CSI measurement reference resource set, and obtain a feedback mechanism satisfying a requirement of the CSI between the user equipment and the transmission point combination.

A specific example is similar to the example in the method for obtaining channel state information shown in FIG. 1, which is not described herein again.

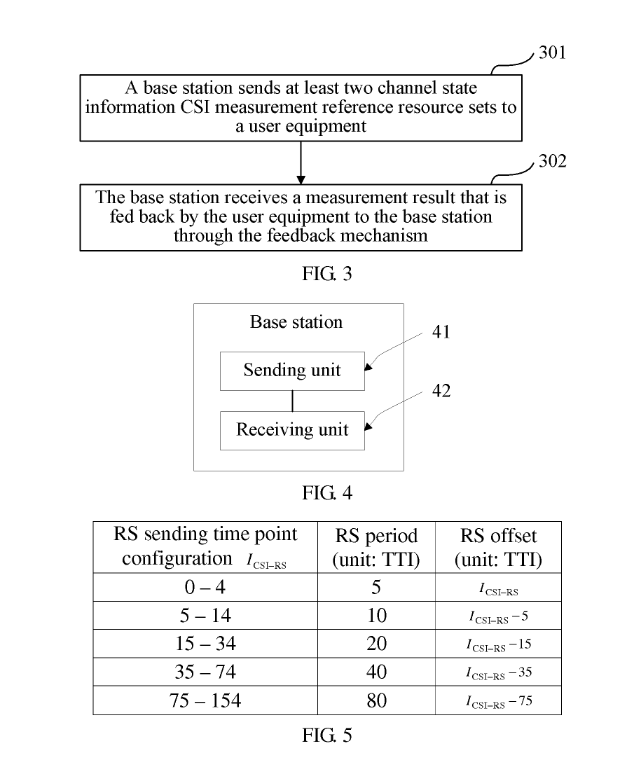

FIG. 3 shows another method for obtaining channel state information according to an embodiment of the present application, and the method includes:

301: A base station sends at least two channel state information CSI measurement reference resource sets to a user equipment.

Further, the user equipment may be enabled to measure, according to each CSI measurement reference resource set of the at least two CSI measurement reference resource sets, CSI corresponding to each CSI measurement reference resource set, and obtain a feedback mechanism corresponding to each CSI measurement reference resource set.

Reference signal RS resources included in different CSI measurement reference resource sets are different; and RSs included in the different CSI measurement reference resource sets have different RS characteristics, and RSs included in the same CSI measurement reference resource set have the same RS characteristic. The RS resource is a time dimension resource (such as a sub-frame) or a frequency dimension resource (such as a sub-band) including an RS; the RS characteristic includes a transmission point that sends the RS, and a configuration of the RS; and the configuration of the RS includes the number of RS antenna ports, an RS pilot pattern, an RS period, and an RS sub-frame offset.

302: The base station receives a measurement result that is fed back by the user equipment to the base station through the feedback mechanism, where the measurement result is CSI between the user equipment and any one or a combination of transmission points among at least two transmission points each corresponding to each CSI measurement reference resource set.

The measurement result may be CSI between the user equipment and any one or a combination of transmission points among at least two transmission points each corresponding to each CSI measurement reference resource set; and the transmission point is a device providing a service for the user equipment, and specifically, the transmission point may be a device such as an antenna.

A specific example of another method for obtaining channel state information shown in FIG. 3 is similar to the example in the method for obtaining channel state information shown in FIG. 1, which is not described herein again.

FIG. 4 shows a base station according to an embodiment of the present application. The base station includes: a sending unit 41 and a receiving unit 42.

The sending unit 41 is configured to send at least two channel state information CSI measurement reference resource sets to a user equipment, so that the user equipment measures, according to each CSI measurement reference resource set of the at least two CSI measurement reference resource sets, CSI corresponding to each CSI measurement reference resource set, and obtains a feedback mechanism corresponding to each CSI measurement reference resource set.

Reference signal RS resources included in different CSI measurement reference resource sets are different; and RSs included in the different CSI measurement reference resource sets have different RS characteristics, and RSs included in the same CSI measurement reference resource set have the same RS characteristic. The RS resource is a time dimension resource (such as a sub-frame) or a frequency dimension resource (such as a sub-band) including an RS; the RS characteristic includes a transmission point that sends the RS, and a configuration of the RS; and the configuration of the RS includes the number of RS antenna ports, an RS pilot pattern, an RS period, and an RS sub-frame offset.

The sending unit 41 may further be configured to, when a measurement result that needs to be fed back by the user equipment to the receiving unit 42 through the feedback mechanism is CSI between the user equipment and a transmission point combination, send an RS configuration corresponding to each CSI measurement reference resource set of the at least two CSI measurement reference resource sets to the user equipment.

The receiving unit 42 is configured to receive a measurement result that is fed back by the user equipment through the feedback mechanism obtained by the user equipment, where the measurement result is CSI between the user equipment and any one or a combination of transmission points among at least two transmission points each corresponding to each CSI measurement reference resource set, and the transmission point is a device providing a service for the user equipment.

The measurement result may be CSI between the user equipment and any one or a combination of transmission points among at least two transmission points each corresponding to each CSI measurement reference resource set; and the transmission point is a device providing a service for the user equipment, and specifically, the transmission point may be a device such as an antenna.

A specific example of the base station shown in FIG. 4 is similar to the example in the method for obtaining channel state information shown in FIG. 1, which is not described herein again.

With the method and apparatus for obtaining channel state information provided in the embodiments of the present application, a user equipment adjusts a feedback mechanism according to different requirements on the feedback mechanism of CSI between the user equipment and different transmission points corresponding to CSI measurement reference resource sets sent by a base station, thereby solving a problem that a feedback mechanism is inflexible when obtaining CSI of wireless channels between different transmission points and a user equipment is implemented in the prior art.

The user equipment and the base station provided in the embodiments of the present application can implement the foregoing method embodiments; and for specific function implementation, reference is made to the description in the method embodiments, which is not described herein again. The method and apparatus for obtaining channel state information provided in the embodiments of the present application are applicable to the field of communications systems, but are not limited thereto.

Persons of ordinary skill in the art may understand that all or a part of the procedures of the methods according to the foregoing embodiments may be implemented by a program instructing relevant hardware. The program may be stored in a computer readable storage medium. When the program is run, the procedures of the methods according to the foregoing embodiments are performed. The storage medium may be a magnetic disk, an optical disk, a read-only memory (Read-Only Memory, ROM), or a random access memory (Random Access Memory, RAM).

The foregoing descriptions are only specific embodiments of the present application, but are not intended to limit the protection scope of the present application. Any variation or replacement that can be easily figured out by persons skilled in the art within the technical scope disclosed in the present application shall all fall within the protection scope of the present application. Therefore, the protection scope of the present application shall be subject to the protection scope of the claims.

What is claimed is:

1. A method for obtaining channel state information, comprising:
receiving, by a user equipment, at least two channel state information CSI measurement reference resource sets sent by a base station, wherein reference signal RS resources comprised in different CSI measurement reference resource sets are different, RSs comprised in the different CSI measurement reference resource sets have different RS characteristics, and RSs comprised in the same CSI measurement reference resource set have the same RS characteristic;
measuring, by the user equipment according to each CSI measurement reference resource set of the at least two CSI measurement reference resource sets, CSI corresponding to each CSI measurement reference resource set, and obtaining a feedback mechanism corresponding to each CSI measurement reference resource set; and
feeding back, by the user equipment, a measurement result to the base station through the feedback mechanism, wherein the measurement result is CSI between the user equipment and any one or a combination of transmission points among at least two transmission points each corresponding to each CSI measurement reference resource set, and the transmission point is a device providing a service for the user equipment.

2. The method according to claim 1, wherein the RS resource is a time dimension resource or a frequency dimension resource; and
the RSs have the same characteristic, which comprises that: the RSs are sent by the same transmission point and the RSs have the same configuration, wherein the RSs have the same configuration, which comprises that: the RSs have the same number of antenna ports, the same RS pilot pattern, the same RS period, and the same RS sub-frame offset.

3. The method according to claim 1, wherein after the receiving, by the user equipment, at least two channel state information CSI measurement reference resource sets sent by a base station, the method further comprises:
when the measurement result that needs to be fed back by the user equipment to the base station through the feedback mechanism is CSI between the user equipment and a transmission point combination, receiving, by the user equipment, an RS configuration that is sent by the base station and corresponds to each channel state information CSI measurement reference resource set of the at least two channel state information CSI measurement reference resource sets, wherein the RS configuration comprises at least one of the following information: the number of RS antenna ports, an RS pilot pattern, an RS period, and an RS sub-frame offset; and
wherein the measuring, by the user equipment according to each CSI measurement reference resource set of the at least two CSI measurement reference resource sets, CSI corresponding to each CSI measurement reference resource set, and obtaining a feedback mechanism corresponding to each CSI measurement reference resource set comprises:
measuring, by the user equipment according to each CSI measurement reference resource set and the RS configuration corresponding to each CSI measurement reference resource set, CSI between the user equipment and the transmission point combination corresponding to each CSI measurement reference resource set, and obtaining a feedback mechanism satisfying a requirement of the CSI between the user equipment and the transmission point combination.

4. A user equipment, comprising:
a receiving unit, configured to receive at least two channel state information CSI measurement reference resource sets sent by a base station, wherein reference signal RS resources comprised in different CSI measurement reference resource sets are different, RSs comprised in the different CSI measurement reference resource sets have different RS characteristics, and RSs comprised in the same CSI measurement reference resource set have the same RS characteristic;
a measurement obtaining unit, configured to measure, according to each CSI measurement reference resource set of the at least two CSI measurement reference resource sets received by the receiving unit, CSI corresponding to each CSI measurement reference resource set, and obtain a feedback mechanism corresponding to each CSI measurement reference resource set; and
a feedback unit, configured to feed back a measurement result to the base station through the feedback mechanism obtained by the measurement obtaining unit, wherein the measurement result is CSI between the user equipment and any one or a combination of transmission points among at least two transmission points each corresponding to each CSI measurement reference resource set, and the transmission point is a device providing a service for the user equipment.

5. The user equipment according to claim 4, wherein the RS resource comprised in the CSI measurement reference resource set received by the receiving unit is a time dimension resource or a frequency dimension resource; and
the RSs have the same characteristic, which comprises that: the RSs are sent by the same transmission point and the RSs have the same configuration, wherein the RSs have the same configuration, which comprises that: the RSs have the same number of antenna ports, the same RS pilot pattern, the same RS period, and the same RS sub-frame offset.

6. The user equipment according to claim 4, wherein,
the receiving unit is further configured to, when the measurement result that needs to be fed back by the feedback unit to the base station through the feedback mechanism obtained by the measurement obtaining unit is CSI between the user equipment and a transmission point combination, receive an RS configuration that is sent by the base station and corresponds to each CSI measurement reference resource set of the at least two CSI measurement reference resource sets, wherein the RS configuration comprises at least one of the following information: the number of RS antenna ports, an RS pilot pattern, an RS period, and an RS sub-frame offset; and
the measurement obtaining unit is further configured to measure, according to each CSI measurement reference resource set received by the receiving unit and the RS configuration corresponding to each CSI measurement reference resource set, CSI between the user equipment and the transmission point combination corresponding to each CSI measurement reference resource set, and obtain a feedback mechanism satisfying a requirement of the CSI between the user equipment and the transmission point combination.

7. A method for obtaining channel state information, comprising:
sending, by a base station, at least two channel state information CSI measurement reference resource sets to a user equipment, so that the user equipment measures, according to each CSI measurement reference resource set of the at least two CSI measurement reference resource sets, CSI corresponding to each CSI measurement reference resource set, and obtains a feedback mechanism corresponding to each CSI measurement reference resource set; and
receiving, by the base station, a measurement result that is fed back by the user equipment through the feedback mechanism, wherein the measurement result is CSI between the user equipment and any one or a combination of transmission points among at least two transmission points each corresponding to each CSI measurement reference resource set, and the transmission point is a device providing a service for the user equipment.

8. The method according to claim 7, wherein the RS resource is a time dimension resource or a frequency dimension resource; and
the RSs have the same characteristic, which comprises that: the RSs are sent by the same transmission point and the RSs have the same configuration, wherein the RSs have the same configuration, which comprises that: the RSs have the same number of antenna ports, the same RS pilot pattern, the same RS period, and the same RS sub-frame offset.

9. The method according to claim 7, wherein after the sending, by a base station, at least two channel state information CSI measurement reference resource sets to a user equipment, the method further comprises:
when the measurement result that needs to be fed back by the user equipment to the base station through the feedback mechanism is CSI between the user equipment and a transmission point combination, sending, by the base station, an RS configuration corresponding to each channel state information CSI measurement reference resource set of the at least two channel state information CSI measurement reference resource sets to the user equipment, so that the user equipment measures, according to each CSI measurement reference resource set and the RS configuration corresponding to each CSI measurement reference resource set, CSI between the user equipment and the transmission point combination corresponding to each CSI measurement reference resource set, and obtains a feedback mechanism satisfying a requirement of the CSI between the user equipment and the transmission point combination.

10. A base station, comprising:
a sending unit, configured to send at least two channel state information CSI measurement reference resource sets to a user equipment, so that the user equipment measures, according to each CSI measurement reference resource set of the at least two CSI measurement reference resource sets, CSI corresponding to each CSI measurement reference resource set, and obtains a feedback mechanism corresponding to each CSI measurement reference resource set; and
a receiving unit, configured to receive a measurement result that is fed back by the user equipment through the feedback mechanism obtained by the user equipment, wherein the measurement result is CSI between the user equipment and any one or a combination of transmission points among at least two transmission points each corresponding to each CSI measurement reference resource set, and the transmission point is a device providing a service for the user equipment.

11. The base station according to claim 10, wherein the RS resource comprised in the CSI measurement reference resource set sent by the sending unit is a time dimension resource or a frequency dimension resource; and
the RSs have the same characteristic, which comprises that: the RSs are sent by the same transmission point and the RSs have the same configuration, wherein the RSs have the same configuration, which comprises that: the RSs have the same number of antenna ports, the same RS pilot pattern, the same RS period, and the same RS sub-frame offset.

12. The base station according to claim 10, wherein:
the sending unit is further configured to, when the measurement result that needs to be fed back by the user equipment to the receiving unit through the feedback mechanism is CSI between the user equipment and a transmission point combination, send an RS configuration corresponding to each CSI measurement reference resource set of the at least two CSI measurement reference resource sets to the user equipment.
